(19) United States
(12) Patent Application Publication
(10) Pub. No.: US 2024/0098583 A1
(43) Pub. Date: Mar. 21, 2024

(54) PDU session continuity for a UE moving between a telecommunications network and a gateway device

(71) Applicants: Koninklijke KPN N.V., Rotterdam (NL); Nederlandse Organisatie Voor Toegepast-Natuurwetenschappelijk Onderzoek TNO, 's-Gravenhage (NL)

(72) Inventors: Toni Dimitrovski, Boskoop (NL); Sanne Jacomine Thepass, The Hague (NL)

(21) Appl. No.: 18/038,408

(22) PCT Filed: Nov. 22, 2021
(86) PCT No.: PCT/IB2021/000912

§ 371 Date: May 23, 2023

(30) Foreign Application Priority Data
Nov. 24, 2020 (EP) 20209377.9

(51) Int. Cl. H04W 36/00

(52) U.S. Cl. CPC H04W 36/0033

(57) ABSTRACT

One aspect of this disclosure pertains to a UE configured for controlling PDU session continuity in a system comprising a gateway device having an established PDU session with a telecommunications network storing a session management context for the gateway device relating to the established PDU session and providing a local network for a plurality of UEs using the established PDU session of the gateway device for data communication with a data network over the telecommunications network. The UE is configured to control the PDU session continuity by transmitting a PDU session establishment request to the telecommunications network to establish a dedicated PDU session with the telecommunications network, wherein the UE is configured to include in the PDU session establishment request at least one reference to the session management context for the gateway device stored in the telecommunications network. Reversely, the UE may be configured to transmit an access request to the gateway device, wherein the UE is configured to include in the access request at least one reference to a session management context of a dedicated PDU session of the UE in the telecommunications network to nest at least one dataflow into the session management context of the established PDU context of the gateway device.

### TECHNICAL FIELD

The present disclosure relates to a UE, a gateway device and a session management system enabling PDU session continuity. In particular, the disclosure relates to packet data unit (PDU) session continuity for a user equipment (UE) moving between a 5G telecommunications network and a 5G residential gateway (RG).

### BACKGROUND

Home devices are usually connected to the internet via a device referred to as gateway device or residential gateway (RG). The gateway device provides a local network and assigns IP addresses to devices in the local network. The gateway device also routes data traffic in and out of the local network. The gateway device may contain a wireless access part, using e.g. WiFi access technology.

The 5G-RG is a Residential Gateway that connects to the 5G core network (5GC) as a UE to represent the devices in the local network. In this manner, the devices (also referred to as UEs) behind the 5G-RG can have a connection to a data network via the 5G-RG without being registered in the 5GC. 3GPP TS 23.316 v16.5.0 specifies such a network arrangement.

The 5G-RG provides access to multiple UEs using a single PDU session that is established for the 5G-RG with a/32 IPv4 or/128 IPv6 address by means of e.g. a framed route making a range of IP addresses or IPv6 prefixes reachable over the single PDU session of the 5G-RG. The single PDU session has a single session management context stored in the 5GC which reduces administrative processing (aggregated traffic counting, charging, etc.) in the 5GC as opposed to having a separate PDU session for each device in the local network. With the framed route, the 5GC can route all data traffic for devices in the local network directly to the 5G-RG over the established single PDU session of the gateway, wherein the 5G-RG then further forwards the data traffic to specific devices in the local network. This way, each device behind the 5G-RG can have a connection to a Data Network (DN) over the 5GC using its assigned IP address, without needing any address translation (e.g. NAT) and without being registered to the 5GC. However, in this case the devices themselves behind the 5G-RG may not have session management contexts in the 5GC because these devices use the PDU session of the 5G-RG.

### SUMMARY

In the network arrangement described above, it may occur that a UE moves out of coverage of the local network (or disconnects from it), and therefore cannot use the 5G-RG for this connection anymore. The local network may comprise a Personal IoT (Internet of Things) Network (PIN). If it would have a session management context in the 5GC for the data network (DN) that is used, it would be able to perform a handover procedure to maintain connectivity as is defined in 3GPP TS 23.502 v16.3.0. However, in the network arrangement described above, the UE is unknown to the 5GC from a PDU session perspective because the established PDU session is only for the 5G-RG and not for a dedicated UE. Although there are ways to perform mobility for the UE in this situation, these require the UE to create a new PDU session for the DNN and get a new address (e.g. an IP address) assigned from the 5GC, causing the previous connection to be broken. Furthermore, handover procedures are meant to move an existing PDU session, which in the case of a UE behind the 5G-RG doesn't exist. The 5G-RG itself should also keep its PDU session after a UE moves out because it may serve other devices in the local network as well.

Another problem is that it is the 5G-RG that assigns IP addresses to UEs rather than the 5GC. The local network is usually a separate administrative domain and decision-making in this domain is decoupled from the 5GC. Since many features of the network are based on the UE's IP address (policy control being the most prevalent one) and its binding to a PDU Session, the movement of sessions with PDU type IP or IPv6 where IP addresses are not allocated and verified by the network is currently not supported.

It is an object of the present disclosure to enable a UE to move between a connection with a local network behind a gateway device and a connection with a telecommunications network (e.g. a 5G network) while maintaining a continuous PDU session.

Hence, in one aspect, the present disclosure pertains to a user equipment, UE, configured for controlling packet data unit, PDU, session continuity in a system comprising a gateway device (e.g. a 5G-RG) that may already have an established PDU session with a telecommunications network (e.g. a 5G telecommunications network) that may store a session management context for the gateway device. The session management context of the gateway device may relate, amongst others, to the established PDU session of the gateway device. The gateway device may provide a local network for a plurality of UEs possibly using the established PDU session of the gateway device for data communication with a data network over the telecommunications network.

In order to continue connectivity at least in part when the UE moves out of or disconnects from the local network provided by the gateway device, the UE may be configured to transmit a PDU session establishment request to the telecommunications network to establish, for example, a dedicated PDU session with the telecommunications network. To that end, the UE may include at least one reference to the session management context for the gateway device stored in the telecommunications network in a request to the network, such as the PDU session establishment request. The reference to the session management context enables the telecommunications network (e.g. a session management system thereof) to find the session management context of the gateway device that also stores session management information of the UE under consideration. The session management information of the UE may then be branched out of the session management context and be used, for example, for establishing a dedicated PDU session for this UE.

It should be appreciated that prior to the request with the reference to the session management context, the UE may need to send a registration request to the telecommunications network, e.g. to a registration system thereof, such as a system running an access and mobility management function (AMF) in a 5GC, to register itself in the telecommunications network, e.g. by storing a mobility management context therein.

Reversely, when the UE moves into the local network, the UE may be configured to transmit an access request to the gateway device to get connected to the local network. The UE may be configured to include, in the access request or in another request, at least one reference providing information for the gateway device to initiate a PDU session modification request to include at least one dataflow of a dedicated PDU session of the UE in the established PDU session of the gateway device. A dataflow relates to a flow of data packets that may have a set of common characteristics. These characteristics can be described in a filter.

In particular, the information in the PDU session modification request from the gateway device refers to a session management context of the UE in the telecommunications network (e.g. a session management system thereof) to find the session management context associated with the dedicated PDU session of the UE and to nest the at least one dataflow into the session management context of the established PDU session of the gateway device so that session continuity is achieved upon connecting to the local network.

It should be appreciated that the gateway device may be a 5G-residential gateway (RG) device providing a local network with non-3GPP wireless access, e.g. a WiFi network, but also providing a local network with 3GPP wireless access, e.g. Proximity Services, or other local area network wireless access technologies. The gateway device may be replaced by any device that is capable of having an established PDU session for plurality of UEs with a telecommunications network, such as a 5GC. The gateway device may comprise an evolved 5G-RG device and/or a device with PIN gateway capabilities.

It should also be appreciated that establishing or modifying a session management context may include initiating, adapting or removing data flows, such as a service dataflow (SDF) and/or a quality of service (QoS) flow from a PDU Session. As mentioned above, a dataflow generally relates to a flow of data packets that may have a set of common characteristics. These characteristics can be described in a traffic filter, which can be a parameter tupple, a traffic flow template (TFT), packet detection rule, or anything alike.

In a 5G telecommunications network, an SDF describes a particular flow of packets having a set of common characteristics defined by a traffic filter which can be a parameter tuple, such as a 5-tupple (IP source address, IP destination address, port source address, port destination address and protocol type) or a 3-tuple (IP source address, IP destination address, port destination address). In 5G, one or more SDFs can be contained in the same QoS flow when the same policy and charging rules apply. The PDU session of the gateway device contains the SDFs and QoS flows of the UEs behind the gateway device.

A reference to a session management context includes anything that allows finding the associated session management context in the telecommunications network, including an identifier of such a context. References may be more general, such as a reference to a device associated with the context (e.g. a 5G-RG identifier or a UE identifier) or a more specific reference referring to particular information with a session management context, e.g. SDF(s) and/or QoS flow(s) for a particular UE within the session management context of the 5G-RG.

In one embodiment, the UE may be configured to include an address (e.g. an IP address or a MAC address) allocated by the gateway device in the request to the network, such as in the PDU session establishment request. In this manner, the address that was assigned by the gateway device to the UE when in the local network can be maintained, if included in the request from the UE, for the UE outside of the local network so that session continuity is achieved when connecting to the telecommunications network. Alternatively, the telecommunications network (e.g. the session management system thereof), may retrieve the address of the UE, for example retrieving this address from the gateway device, for example when the PDU session establishment request with the reference to the session management context of the gateway device is received.

In one embodiment, the UE may be configured to determine availability of the local network and, possibly, to transmit the PDU session establishment request when the local network is unavailable and, possibly, the access request when the local network is available. The UE may e.g. determine a signal level from the local network and use this level to determine if or when to transmit the PDU session establishment request to the telecommunications network or the access request to the local network, e.g. by comparing the signal level with a signal level threshold. This embodiment facilitates control by the UE of the session continuity.

In one embodiment, the UE may be configured to receive the at least one reference to the session management context of the gateway device in a message from the gateway device. The reference may be received, for example, during connection establishment with the local network or during allocation of an address to the UE by the gateway device. The reference may e.g. be obtained in a WiFi network via an Association Response message. Another option is that the UE may receive the reference during the IP address allocation which may e.g. be conducted with DHCP (or host booting protocols, i.e. Neighbor Discovery Protocol [RFC1122] with ICMPv6) after the association process on layer 2 is complete. This decouples obtaining the reference from the access type since DHCP can be used over different lower layer medium access technologies. The reference may be included in the Option field of a DHCP message [RFC2939] or ICMPv6 Router Advertisement message or in any other field.

In one embodiment, the UE may be configured to include a data network name, DNN, in the PDU session establishment request referring to a 5G virtual network (5G-VN) associated with the established PDU Session of the gateway device. The 5G-VN may also be known for example as 5G LAN, 5G LAN VN or VN group. One of the useful features is that discovery and selection of the session management system in the telecommunications network may e.g. be narrowed down since a single system, e.g. a single SMF, handles all devices connecting to the 5G-VN DNN.

In one embodiment, the UE may be configured to receive an authentication token from the gateway device and to transmit the authentication token in a request, optionally with the PDU session establishment request, to the telecommunications network. The embodiment enables the telecommunications network (e.g. the session management system thereof) to verify authentication of the UE with the gateway device when requesting continuity of the PDU session.

In one embodiment, the UE may be configured to include the reference to the session management context associated with the dedicated PDU session of the UE in the access request to the gateway device in, e.g., an Association Request, an ICMPv6 Router Solicitation, a DHCP Discover request or a DHCP Request request when the UE connects to the local network.

In one embodiment, the UE may be configured to include a data network name, DNN, in the access request referring to a 5G virtual network, wherein the DNN is different from the DNN associated with the established PDU session of the gateway device. When determining this DNN, the gateway device may be triggered to establish a further PDU session with the telecommunication network and include at least one data flow of the UE in the further PDU session. This embodiment may be used when the gateway device offers guest access and the UE desires to connect to a home local network associated with the DNN provided in the access request.

Other embodiments of the disclosure involve methods in the UE for maintaining PDU session continuity.

In one aspect, a method in a UE is disclosed in a system comprising a gateway device (e.g. a 5G-RG) that may already have an established PDU session with a telecommunications network (e.g. a 5G telecommunications network) that may store a session management context for the gateway device. The session management context of the gateway device may relate, amongst others, to the established PDU session of the gateway device. The gateway device may provide a local network for a plurality of UEs possibly using the established PDU session of the gateway device for data communication with a data network over the telecommunications network.

The method may involve transmission of a PDU session establishment request to the telecommunications network to establish, for example, a dedicated PDU session with the telecommunications network. To that end, the method may involve the UE including at least one reference to the session management context for the gateway device stored in the telecommunications network in a request to the network, such as the PDU session establishment request. The reference to the session management context enables the telecommunications network (e.g. a session management system thereof) to find the session management context of the gateway device that also stores session management information of the UE under consideration. The session management information of the UE may then be branched out of the session management context and be used, for example, for establishing a dedicated PDU session for this UE.

Reversely, when the UE moves into the local network, for example, the method involves to transmit an access request to the gateway device to get connected to the local network. The method may involve including, in the access request or in another request, at least one reference providing information for the gateway device to initiate a PDU session modification request to include at least one dataflow of a dedicated PDU session of the UE in the established PDU session of the gateway device. A dataflow relates to a flow of data packets that may have a set of common characteristics. These characteristics can be described in a filter. In particular, the information in the PDU session modification request from the gateway device identifies a session management context of the UE in the telecommunications network (e.g. a session management system thereof) to find the session management context associated with the dedicated PDU session of the UE and to nest the at least one dataflow into the session management context of the established PDU session of the gateway device so that session continuity is achieved upon connecting to the local network.

Other aspects of the disclosure involve methods executed by the UE to operate as specified in one or more of the embodiments of the UE above, including the embodiments of claims 2-8.

The telecommunications network may be a 3GPP 5G network including a radio access network and/or fixed access network and a 5G core (5C) network as standardized in 3GPP. In such telecommunications networks, network functions may be defined which typically involve a set of software running on a system (e.g. a cloud platform) rather than an integrated product with dedicated hardware. Hence, in the present disclosure, reference will be made to systems that perform a particular function, e.g. a session management system performing a session management function (SMF) and a policy control system performing a policy control function (PCF).

Other aspects of the present disclosure involve the session management system in the telecommunications network and the gateway device and methods therefore.

The session management system may have direct or indirect access to a session management context stored in the telecommunications network including at least one established PDU session for a gateway device. The gateway device may, optionally, have allocated addresses to UEs in a local network for data exchange with a data network over the telecommunications network using the established PDU session of the gateway device.

The session management system may be configured for receiving a PDU session establishment request from a UE when the UE connects to the telecommunications network. The request contains at least one reference to the stored session management context of the gateway device. The session management system may be configured for tracing the stored session management context of the gateway device based on the reference and use at least a part of the identified session management context for establishing a dedicated PDU session for the UE. This enables the session management system to provide session continuity for the UE.

Reversely, the session management system may be configured to receive a PDU session modification request from the gateway device, for example when the UE connects to the local network, to modify the established PDU session of the gateway device to include at least one dataflow from a dedicated PDU session of a UE in the established PDU session. To that end, the PDU session modification request may include a reference to the session management context of the dedicated PDU session of the UE. The session management system may then release the dedicated PDU session of the UE.

In one embodiment, the session management system may be configured to receive or retrieve an address allocated by the gateway device to the UE, from at least one of the UE and the gateway device with or upon receiving the request, e.g. the PDU session establishment request, and assign the received address to the UE for the dedicated PDU session. The embodiment enhances PDU session continuity.

In one embodiment, the session management system may be configured to execute performing a PDU session modification procedure to modify the established PDU session for the gateway device during or after establishing the dedicated PDU session. In this embodiment, the established PDU session of the gateway device may be adapted to account for the branched out dataflow for the UE that has left the local network. Adaptation of the established PDU session of the gateway device may include removing dataflows, e.g. SDFs and possibly QoS flows of the UE from the session management context of the gateway device.

Furthermore, in one embodiment, the session management system may be configured to add at least one dedicated forwarding rule in the telecommunications network (e.g. in the system performing a user plane function (UPF) to route data for the UE to the dedicated PDU session. The session management system may also update the access part of the telecommunications network to remove any existing QoS flows that the UE's SDFs were using and are not being used by other UE's SDFs anymore.

When the dataflow of a dedicated PDU session of the UE is nested into the established PDU session of the gateway device, the session management system may be configured to release the dedicated PDU session of the UE to free up resources.

In one embodiment, the session management system may be configured to receive an authentication token from the UE in the PDU session establishment request and may transmit the authentication token to the gateway device or receive the authentication token from the gateway device in order to authenticate the UE or the PDU session establishment request from the UE. The embodiment enables the session management system to verify with the gateway device to authenticate the UE if or when requesting continuity of the PDU session. Authentication verification may be conducted in the gateway device, in the session management system or in both.

In one embodiment, the telecommunications network comprises a policy control system configured for storing a policy control context of a gateway device and/or a UE.

For a UE outgoing of the local network, the session management system may be configured to interact with the policy control system handling the established PDU session of the gateway device using the at least one reference received from the UE to identify the policy control context of the gateway device and to use at least part of the policy context information of the gateway device associated with the UE for the dedicated PDU session. Reversely, for an incoming UE, the session management system may be configured to interact with the policy control system handling the dedicated PDU session of the UE using the at least one reference received from the gateway device to identify the policy control context of the UE and to use the policy control context information of the UE for the established PDU session of the gateway device. This embodiment allows continuity of the policy control for the PDU session of the UE.

In one embodiment, the session management system is configured for receiving and storing an indication from a gateway device in a PDU session establishment request for the gateway device. The indication may indicate that the gateway device is available for assigning addresses to UEs. In one further embodiment, the session management system is configured for requesting an address from the gateway device in response to receiving a PDU session establishment request from a UE and receiving the address from the gateway device. The session management system may, but this is not necessary, send the request to the appropriate gateway device as a result from the indication received from the gateway device during PDU establishment with the session management system. In yet another embodiment, the session management system may be configured to send an address assigned by the gateway device to a UE in a PDU session establishment accept message to the UE. These embodiments facilitate using the same address in the local network as an address previously used in the telecommunications network.

Other embodiments of the disclosure involve methods in the session management system for maintaining PDU session continuity.

In one aspect, a method in a session management system is disclosed. The session management system may have direct or indirect access to a session management context stored in the telecommunications network including at least one established PDU session for a gateway device. The gateway device may, optionally, have allocated addresses to UEs in a local network for data exchange with a data network over the telecommunications network using the established PDU session of the gateway device. In the method, the session management system may receive a PDU session establishment request from a UE, for example when the UE connects to the telecommunications network. The request may contains at least one reference to the stored session management context of the gateway identifying the stored session management context of the gateway device based on the reference. The method may also include using at least a part of the identified session management context for establishing a dedicated PDU session for the UE This enables the session management system to provide session continuity for the UE.

Reversely, the method for the session management system may involve receiving a PDU session modification request from the gateway device, for example when the UE connects to the local network, to modify the established PDU session of the gateway device to include at least one dataflow from a dedicated PDU session of a UE in the established PDU session. To that end, the method involves that the PDU session modification request include a reference to the session management context of the dedicated PDU session of the UE. The method may also involve the session management system to release the dedicated PDU session of the UE.

Other aspects of the disclosure involve methods executed by the session management system to operate as specified in one or more of the embodiments of the session management system above, including the embodiments of claims 10-14.

The gateway device may be configured to provide a local network for a plurality of UEs and may provide an established PDU session with a telecommunications network for data communication with a data network over the telecommunications network.

The gateway device may be configured to transmit, and possibly update when the established PDU session changes, for example, a reference to a session management context stored in the telecommunications network associated with the established PDU session of the gateway device to at least one of the plurality of UEs over the local network. The UE can use this reference in the PDU session establishment request to allow continuity of the PDU session when the UE disconnects or moves out of the local network.

Reversely, when, for example, the UE connects to the local network, the gateway device is configured receive at least one reference to a session management context stored in the telecommunications network associated with a dedicated PDU session of a UE connecting to the local network of the gateway device. The gateway device may then transmit a PDU session modification request including the reference over the telecommunications network to include at least one dataflow of the dedicated PDU session in the established PDU session of the gateway device.

In one embodiment, the gateway device may also provide the address of the UE to the UE and/or to the session management system.

In one embodiment, the gateway device may be configured to receive the address from the telecommunications network and to compare the received address with the address allocated to the UE over the local network. This embodiment allows for further authentication control to allow UEs to continue a PDU session. Alternatively, the gateway device may provide the allocated address of the UE to the telecommunications network, e.g. to the session management system, to enable authorization verification in the telecommunications network.

In one embodiment, the gateway device may be configured to receive a data network name, DNN, in the access request referring to a 5G virtual network, wherein the DNN is different from the DNN associated with the established PDU session of the gateway device. When determining this DNN, the gateway device may be triggered to establish a further PDU session, different from the already established PDU session, with the telecommunication network and include at least one data flow of the UE in the further PDU session. This embodiment may be used when the gateway device offers guest access and the UE desires to connect to a home local network associated with the DNN provided in the access request.

In one embodiment, the gateway device is configured for transmitting an indication to a session management system, the indication indicating that the gateway device is available for assigning addresses to UEs. In one further embodiment, the gateway device is configured to receive a request from a session management system for an address for a UE and providing the address to the session management system for the UE. In one embodiment, the gateway device is configured to allocate an address to a UE in a local network provided by the gateway device, wherein the allocated address corresponds to the address provided to the session management system. These embodiments facility providing the same address in the local network as previously used by the UE in the telecommunications network.

Other embodiments of the disclosure involve methods in the gateway device for maintaining PDU session continuity.

In one aspect, a method in a gateway device is disclosed. In one embodiment, the method involves the gateway device to provide a local network for a plurality of UEs and may provide an established PDU session with a telecommunications network for data communication with a data network over the telecommunications network. The method may involve transmission, and possibly updating when the established PDU session changes, of a reference to a session management context stored in the telecommunications network associated with the established PDU session of the gateway device to at least one of the plurality of UEs over the local network. The UE can use this reference in the PDU session establishment request to allow continuity of the PDU session when the UE disconnects or moves out of the local network.

Reversely, when, for example, the UE connects to the local network, the method in the gateway device involves receiving at least one reference to a session management context stored in the telecommunications network associated with a dedicated PDU session of a UE connecting to the local network of the gateway device. The gateway device may then transmit a PDU session modification request including the reference over the telecommunications network to include at least one dataflow of the dedicated PDU session in the established PDU session of the gateway device.

Other aspects of the disclosure involve methods executed by the gateway device to operate as specified in one or more of the embodiments of the gateway device above, including the embodiments of claims 16-18.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the person's computer, partly on the person's computer, as a stand-alone software package, partly on the person's computer and partly on a remote computer, or entirely on the remote computer or server. In the latter scenario, the remote computer may be connected to the person's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1A is a schematic illustration of a 5G network architecture according to the prior art;

FIG. 1B is a schematic illustration of a 5G Core network (5GC) according to the prior art;

FIG. 1C is a schematic illustration of a PDU session establishment request in a 5G network according to the prior art;

FIG. 2A is a schematic illustration of a local network comprising a 5G Residential Gateway providing wireless coverage for a plurality of UEs connected to a 5GC via either wireline or wireless connections according to an embodiment of the invention;

FIG. 2B is a schematic illustration of a UE moving between a local network and a telecommunications network;

FIG. 3 is a schematic illustration of some steps of a PDU session mobility procedure from a local network of a gateway device to a 5G telecommunications network according to an embodiment of the invention;

FIG. 4 is a schematic illustration of some steps a PDU session mobility procedure from a 5G telecommunications network to a local network of a gateway device according to an embodiment of the invention;

FIG. 5 is a schematic illustration of some steps of a PDU session mobility procedure from a 5G telecommunications network to a local guest network according to an embodiment of the invention;

FIG. 6 is a schematic illustration of some step of address assignment by a telecommunications network to a UE; and

FIG. 7 depicts a processing system according to an embodiment for a processing device or a server system.

### DETAILED DESCRIPTION OF THE DRAWINGS

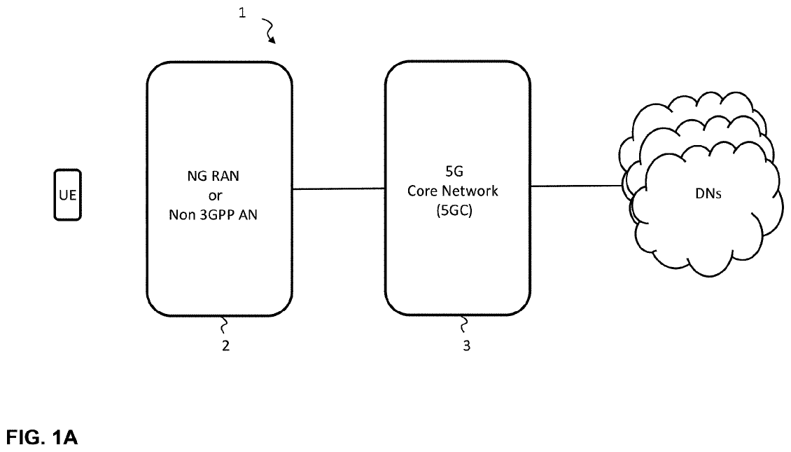

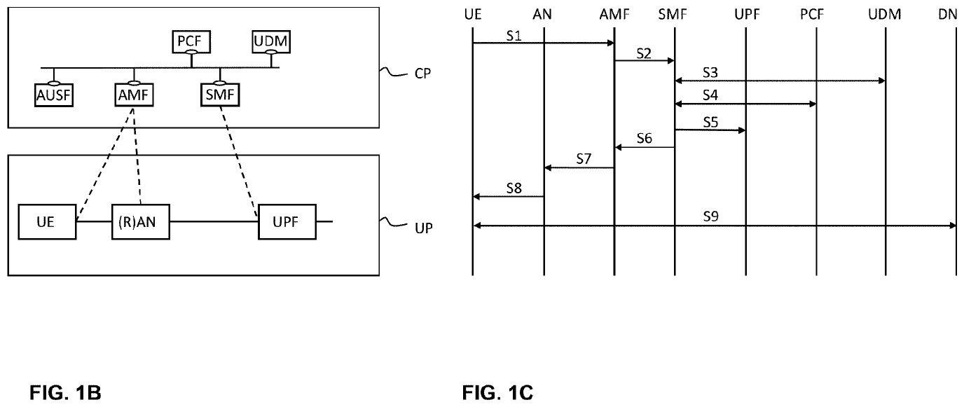

FIG. 1A is a schematic illustration of a 5G network architecture 1 according to the prior art. The 5G network is composed of a 5G access network 2 and a 5G core network (5GC) 3. The access network is made up of a new-generation radio access network (NG-RAN) which uses the 5G new radio interface (NR). The NG-RAN comprises 5G base stations, referred to as gNB's (not shown) which are connected to the 5GC and to each other. The access network 2 also comprises a non-3GPP access network (e.g. WiFi, xDSL, etc) connecting to the 5GC. The different network entities are connected by an underlying TCP/IP transport network. The 5G network architecture is connected to a plurality of data networks DN. Data networks can be the internet, an operator specific network, a dedicated network, etc.

FIG. 1B shows a 5GC in a service-based architecture in combination with a UE and (R)AN. The 5GC comprises many systems that are defined in terms of network functions (NF) that provide services as sets of interactions between two or more network functions. The upper part of FIG. 1B shows a set of network functions that form the 5G control plane CP. Amongst others, the control plane comprises an access and mobility management function (AMF) that handles most signalling coming from and going to the UE. The AMF also interacts with other functions in the control plane. The AMF does not handle session management but forwards session-related messages to and from a system performing a session management function (SMF), hereinafter referred to as session management system. The SMF performs establishment, modification and release of PDU sessions. The control plane may also comprise a system performing a policy control function (PCF) that provides policy rules (QoS, filtering, charging) to other control plane functions, such as the SMF. The 5G Policy Architecture is defined in more detail in 3GPP TS 23.503. Further functions that are comprised in the control plane include the unified data management function (UDM) and the authentication server function (AUSF). The UDM is partly equivalent of the home server system HSS in 3G and 4G networks and is a repository for UE-related information, such as credentials, identifiers, AMF details, and SMF PDU sessions. The AUSF supports authentication for 3GPP and non-3GPP access.

For the user plane UP, the lower part in FIG. 1B, the UE communicates via the access network 2 with a system performing a user plane function (UPF). Data is tunnelled between the access network and the UPF, sometimes referred to as the NG-U tunnel. The main task of the UPF is to process and forward user data. The UPF is controlled by the SMF and connects with external data networks DN.

The system performing the session management function SMF has the responsibility for setting up connectivity for the UE toward data networks as well as managing the user plane for that connectivity. In order to connect to a DN, the UE requests establishment of a packet data unit (PDU) Session. The PDU is the basic end-user protocol type carried by the PDU session, e.g. IP packets or Ethernet frames. Each PDU session provides an association between the UE and a specific DN.

FIG. 1C provides a simplified PDU Session Establishment procedure as set out in more detail in 3GPP TS 23.502, v16.3.0.

In step S1, the UE transmits a PDU Session Establishment Request after the UE is registered with the 5GC sending a registration request to the AMF. The PDU Session Establishment Request is transmitted as a session management container in a NAS message to the AMF. The PDU Session Establishment Request contains the PDU session ID, the Requested PDU Session Type, and, possibly, a data network name (DNN). The PDU Session ID is a unique identifier generated by the UE that is different for different PDU sessions. The Request Type indicates “Initial Request” if the PDU Session Establishment is a request to establish a new PDU session and indicates “Existing PDU Session” if the PDU Session Establishment Request refers to an existing PDU session between 3GPP access and non-3GPP access or to a PDU Session handover from an existing PDN connection in a 4G EPC. When the access network receives the PDU Session Establishment Request, the NAS message is encapsulated in an N2 message towards the AMF.

The AMF selects an SMF as described in TS 23.501 and may either use a DNN provided by the UE or select a (default) DNN using e.g. subscription information from UDM. Based on the Request Type, the AMF determines whether the PDU Session Establishment request relates to an existing PDU session or to a new PDU session. In step S2, the AMF sends a message Nsmf_PDUSession_CreateSMContext Request to the SMF containing the PDU Session Establishment Request, DNN information, a PCF ID, etc. when the AMF is not already associated with an SMF. Else, the AMF sends_PDUSession_UpdateSMContextRequest to the SMF. If the Request Type indicates “Existing PDU Session”, the SMF determines that the request is due to switching between 3GPP access and non-3GPP access. The SMF may then identify the existing PDU Session based on the PDU Session ID. In such a case, the SMF does not create a new SM context but instead updates the existing SM context

The SMF may also interact with the UDM and PCF based on the data provided by the UE as can be observed from steps S3 and S4 to obtain subscription data and policy rules.

In step S5, the SMF interacts with the UPF to establish a session for the user plane. The SMF sends an N4 Session Establishment Request to the selected UPF and provides packet detection, enforcement, forwarding and reporting rules to be installed on the UPF for this PDU Session if the Request Type is “Initial Request”. Otherwise, the SMF sends an N4 Session Modification Request. The UPF acknowledges the respective request with an N4 Session Establishment/Modification Response. In this procedure, the SMF obtains tunnel information from the UPF.

In step S6, the SMF interacts with the AMF. Following the successful creation of a tunnel end point, the SMF sends Namf_Communication_N1 N2MessageTransfer with tunnel information for N2 message and PDU session details in N1 Container and provide the representation of the SM context or updated SM context to the AMF.

In step S7, the AMF sends a N2 PDU Session Setup Request to the appropriate gNB of the access network AN along with N2 session management parameters received from SMF as QFIs, QoS Profile. The transmission from the AMF to the access network AN also includes the NAS message destined to the UE, including session parameters like QoS Rules and UE IP address.

The gNB establishes the tunnel based on the information received from the AMF and sets up a tunnel end point and forwards information to the UE for setting up a PDU session in step S8. The gNB also reports back to the AMF that subsequently informs the SMF about the successful setup of the tunnel.

After this step, the tunnel is established and the PDU session exists between the UE and the UPF allowing data transfer with the DN, indicated by step S9.

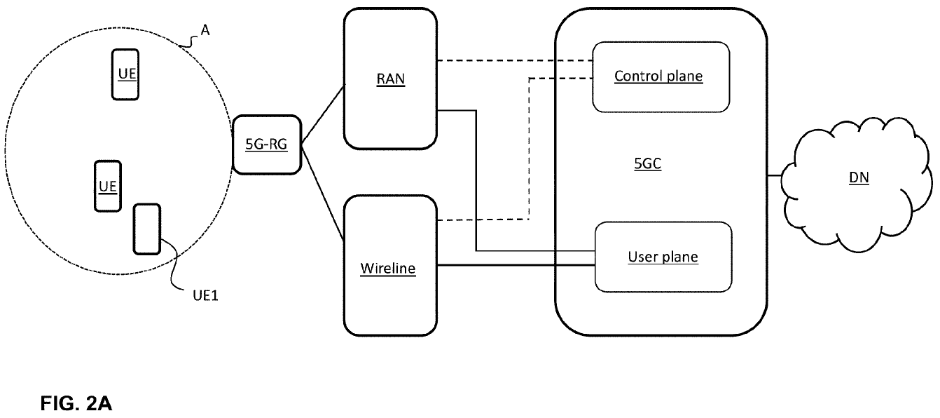

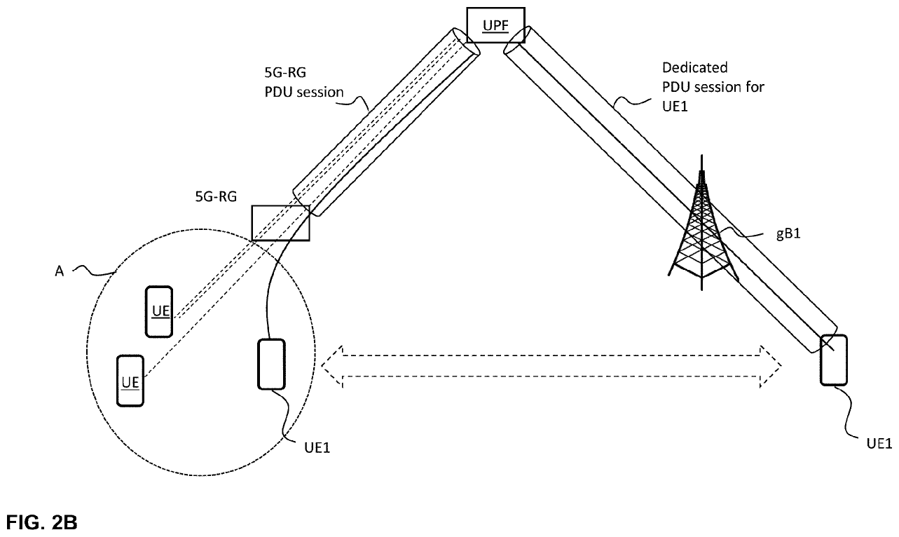

FIG. 2A is a schematic illustration of a local network comprising a gateway device, such as a 5G Residential Gateway (5G-RG), providing wireless coverage in an area A for a plurality of UEs connected to a 5GC via either a wireline access network or a wireless access network containing gNBs. The 5G-RG may connect to the 5GC as a UE in a manner corresponding to FIG. 1C interacting with functions in the control plane and user plane and forwards traffic to and from the UEs in the local network via the PDU session. The 5G-RG may assign addresses, e.g. IP addresses or MAC addresses, to UEs in the local network. In this manner, the UEs behind the 5G-RG can make use of a single PDU session of the 5G-RG for a data network DN without being registered in the 5GC and using the IP address assigned by the telecommunications network to the 5G-RG.

With framed routing, a range of IP addresses or IPv6 prefixes are reachable over a single PDU session. The UEs have IP addresses within the IP address range of the framed route. Also, the UPF has forwarding rules (based on the framed route) enabling traffic routing for subnets behind the 5G-RG in the 5G-RG PDU session.

One or more of the UEs under the wireless coverage of the 5G-RG may move out of the area of the 5G-RG or disconnect from the 5G-RG. In one embodiment, a UE may be configured to determine availability of the local network provided by the 5G-RG. In one embodiment, the UE may e.g. determine a signal level from the local network provided by the 5G-RG. If the UE determines that the local network is unavailable, it may perform one or more actions disclosed below.

When the local network is no longer available, UE1 detecting this situation can no longer make use of the PDU session of the 5G-RG. The below disclosure describes one embodiment for maintaining PDU session continuity while the PDU session of the 5G-RG is also maintained for serving the UE(s) remaining in the local network.

When a UE is in the local network coverage it requests connectivity from the 5G-RG. Depending on the access technology used by the 5G-RG in the local network, different connectivity establishment procedures can be used. In the case of WiFi access, this is the authentication and association process between a UE and a WiFi access point. In the association process with the 5G-RG, the UE may receive a session management context reference, described in further detail below, in the Association Response message from the 5G-RG. Another embodiment entails that the UE receives the session management context reference during the address assignment which is usually done with DHCP (or host booting protocols, i.e. Neighbor Discovery Protocol [RFC1122] with ICMPv6) after the association process on layer 2 is complete. This may decouple obtaining the session management context reference from the access type since DHCP can be used over different lower layer medium access technologies. The session management context reference may e.g. be included in the Option field of a DHCP message [RFC2939] or ICMPv6 Router Advertisement message.

The session management context reference that the UE uses may be provided by the 5G-RG when UE gets access to the gateway device as described above, and may be appropriately updated if the reference changes during the UEs connectivity via the gateway device. In one embodiment, the session management context reference comprises a reference to the 5G-RG, such as a 5G-RG ID or any other reference or identifier that is configured in the system to assist in identifying the session management context. Other information obtained during the access procedure with the 5G-RG may include at least one of a PDU Session ID, a list of SDFs and QoS flow IDs and the IP address that the UE uses in the local network as may be used, inter alia, to construct a more specific reference.

When the UE is associated with/connected to the 5G-RG, all types of traffic may be routed via the 5G-RG PDU Session towards the data network DN via a 5G-RAN or via wireline access and the 5GC as shown in FIG. 2A. In one other embodiment, the 5G-RG is an Internet Gateway for the UE. In case QoS is configured in the 5G-RG, the 5G-RG may map SDFs with certain QoS from the UE to appropriate QoS flows in the PDU Session of the 5G-RG via the 5GC. These SDFs can be established with the UE's IP address, rather than the 5G-RG IP address.

In one embodiment, the UE is configured to be allocated an address, such as an IP address, by the gateway device, such as the 5G-RG, and use this address in the PDU session establishment request to the telecommunications network when the local network is no longer available as will be described in further detail below.

FIG. 2B is a schematic illustration of a UE, UE1, moving between a local network provided by the 5G-RG in coverage area A and a telecommunications networks presented by the gNB of a 5G RAN.

UEs in the coverage area A benefit from the 5G-RG PDU session existing between the 5G-RG and the UPF of the 5GC, presented as a pipe in FIG. 2B, containing several SDFs/QoS flows indicated by the dashed lines within the pipe. UE1 also uses the 5G-RG PDU session for its SDF/QoS flow, indicated by the solid line within the pipe, as discussed above.

When the UE moves out of the coverage area A of the 5G-RG, indicated by the dashed double arrow, it establishes a new, dedicated PDU session for itself for local network traffic using the reference to the session management context for the UE1, so that the dedicated PDU session can make use of the existing session information for UE1 when UE1 was still served by the 5G-RG to obtain session continuity. Hence, the SDF/QoS flow information is branched out of the 5G-RG PDU session management context and included in the session management context for the dedicated PDU session. This information is stored in the 5GC, e.g. in an SMF system. The 5G-RG PDU session is maintained.

Reversely, when UE1 moves back into coverage area A of the 5G-RG, again indicated by the dashed double arrow, UE1 wants to make use of the 5G-RG PDU session. UE sends a reference to its own session management context associated with the dedicated PDU session as stored in the telecommunications network to the 5G-RG in order to enable the 5G-RG to interact with the telecommunications network, e.g. with the SMF system, to nest the session management context for UE1 into the session management context of the PDU session of the 5G-RG. For this purpose, the 5G-RG initiates a PDU session modification request to the telecommunications network.

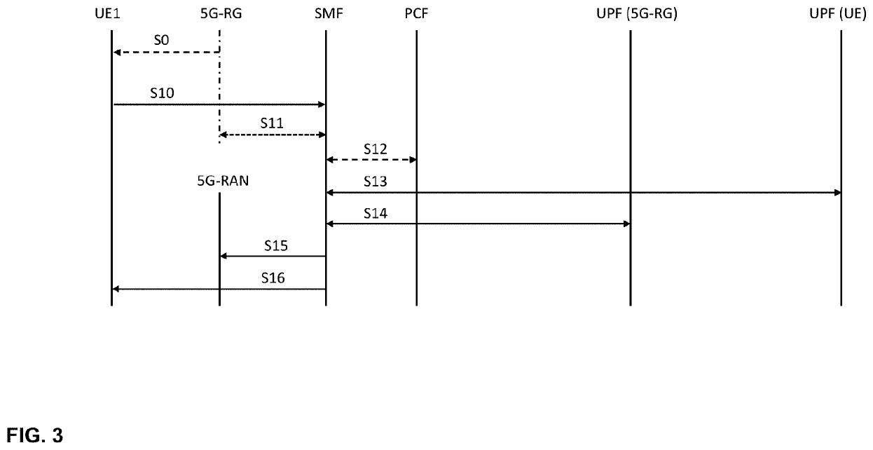

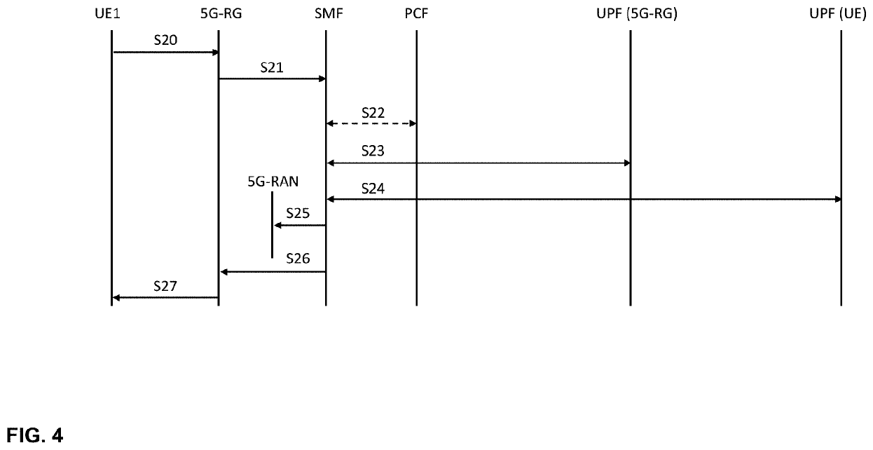

FIGS. 3 and 4 are schematic illustrations of examples of some steps in session mobility procedures performed by the UE, the gateway device and the SMF system when UE1 is moving out of the local network resp. moving (back) into the local network provided by the 5G-RG.

In general, when UE1 is moving out of the coverage of the 5G-RG, UE1 transmits a PDU Session Establishment Request after having registered in the 5GC (to establish a mobility management context) for a new or existing PDU session. This new PDU session, the dedicated PDU session of UE1 in FIG. 2B, is used by the UE for local network traffic while the 5G-RG PDU session, is also maintained as mentioned above. In order for the SMF system in the 5GC to be able to use PDU session information including any active Service Data Flows (SDFs) and QoS flows of the 5G-RG for UE1, UE1 may send the session management context reference when it initiates mobility from the local network to the 5GC. The reference is sent to the SMF during the PDU session establishment procedure, upon which the SMF may create a dedicated PDU session for UE1 and remove any SDFs (and possible QoS Flows if they are not bound to any SDF due to the mobility) related to the UE1 from the 5G-RG PDU Session. To that end, the SMF identifies session information stored in the 5GC associated with the PDU Session of the 5G-RG and uses this information for the dedicated PDU session of UE1.

In more detail, the PDU Session Establishment Request to the SMF and the PDU Session Modification procedure, as standardized in 3GPP TS 23.502, v16.3.0, clause 4.3.2. are changed. The below description addresses some aspects of these changes and illustrates these with reference to FIG. 3. It should be appreciated that the sequential order of the steps may be different and that further steps may be included before or after an indicated step in the procedure.

Step S0 precedes the PDU Session Establishment procedure. In step S0, UE1 receives a reference to the session management context for the PDU session of the 5G-RG when accessing or being connected to the local network.

In step S10, when, for example, the wireless signal strength of the local network decreases below a certain threshold, the UE sends PDU Session Establishment request to the SMF (via the AMF), containing, for example, an indication “Existing PDU Session” and the DNN of the 5G-VN which is either configured in the UE or there exists a UE Route Selection Policy that specifies which DNN to use for which traffic (TS 23.503, clause 6.6.2 UE Route Selection Policy information). The UE also includes the previously received (e.g. from the 5G-RG) session management context reference associated with the PDU Session information of the 5G-RG. This reference in the PDU Session Establishment Request may contain the 5G-RG ID (SUPI, IMSI, 5G-TMSI, GPSI, or any other identifier that the SMF can translate to the 5G-RG ID by using Nudm_SDM_Get [Identifier Translation], see 23.502 Table 5.2.3.3.1-1: UE Subscription data types), PDU Session ID and, optionally, a list of SDFs and QoS flow IDs that need to be transferred from the 5G-RG PDU Session to the UE's own new PDU Session. The UE may also provide its assigned address, e.g. the IP address, in this request so it can be kept for the dedicated PDU session. Alternatively, the UE can omit including the SDFs and QoS Flow IDs and the SMF can find them from the UE's address. If PCF is deployed, the PCF may be the one that will find the SDFs and QoS Flow IDs from the UE IP address and rebind them to the new dedicated PDU Session as described in more detail below. PCF interaction with the SDF is illustrated by step S12.

It is noted that, if the UE is served by a different AMF (not shown in FIG. 3) than the 5G-RG, the AMF can select the SMF that serves the 5G-VN because only one SMF can serve a single 5G-VN.

After receiving the PDU Session Establishment Request of step S10 of UE1, the SMF processes this PDU Session Establishment Request. When the SMF receives the PDU Session Establishment Request, the SMF may become aware that the UE is moving out of a local network because this is signaled by the received session management context reference. The reference assists the SMF in tracing the PDU Session information (in its own Session Management contexts) of the 5G-RG.

In one embodiment, the SMF may perform authorization of the local network mobility by verifying whether the UE identifier is in the list of allowed local networking devices for the 5G-RG PDU Session. This list may be part of the Session Management Subscription data that may have been fetched previously by the SMF from the UDM (not shown in FIG. 3). Alternatively, the SMF may request for authorization from the 5G-RG including the address of the UE as shown by step S11. This would allow for more dynamic authorization procedure and prevention of unauthorized access. The SMF may also verify if the address given by the UE corresponds to the subnet from the framed route(s) in the 5G-RG's PDU session.

In one embodiment for authorization of the UE, the SMF may request UE authorization from the 5G-RG as shown by step S11, allowing for more dynamic authorization procedure and prevention of unauthorized access. The SMF may include the address, e.g. the IP address, of the UE in this authorization request for UE authorization as mentioned above. However, since the IP address of the UE may be mapped to the 5G-RG PDU session (in the framed route) and could therefore be obtained rather easily, any device with this information could pretend to be the UE, and access the PDU session from the 5G-RG by asking for the mobility procedure.

To prevent this, additional authentication may be performed by the 5G-RG, SMF (or other function/application) before performing authorization, to ensure that the UE is a known device of the 5G-RG and to avoid impersonation of the UE. This may be achieved by the 5G-RG sending a different authentication token to the UE during access establishment or during connection with the 5G-RG, in which the token (in contrast to the UE IP address) is only known to the UE and 5G-RG. This could be a pre-arranged shared secret between the 5G-RG and the UE. When the UE1 initiates the PDU Session Establishment request, the token may be sent along with the session management context reference to the PDU session of the 5G-RG in step S10, which can then be verified by at least one of the 5G-RG and the SMF during step S11. In addition to or as alternative for the shared secret, any other challenge-response authentication can be used to authenticate the UE before authorization.

After finding the 5G-RG PDU Session using the session management context reference and the necessary SDFs and QoS Flows, the SMF creates the new PDU Session with the selected UPF in step S13. The UPF may be different from the 5G-RG UPF but this not necessary (a regular UPF selection procedure as described in TS 23.501 clause 6.3.3 User Plane Function Selection may be used). The procedure for the UE may then continue for the largest part as the basic PDU Session Establishment procedure specified in TS 23.502 clause 4.3.2.2 from step 4, possibly skipping step 19 wherein the (IP) address is sent by the SMF to the UE as also described with reference to FIG. 1C. In a preferred embodiment, the UE sends the address assigned by and used behind the gateway device to the SMF to be maintained for the dedicated PDU session.

Either at the end of the PDU Session Establishment procedure or right before step 17, the SMF also initiates the PDU Session Modification procedure for the PDU Session of the 5G-RG in step S14 of FIG. 3. This is performed by starting with step 1d from the procedure in TS 23.502, v16.3.0, clause 4.3.3.2 UE or network requested PDU Session Modification (non-roaming and roaming with local breakout). This modification includes removing the SDFs and possibly QoS flows (the ones previously created for the UE's dedicated PDU Session) and adding a more specific forwarding rule in the UPF to route traffic destined to the UE in the UE's PDU Session. This is part of step 8 from the procedure in TS 23.502, v16.3.0.

The SMF may also, in step S15, update the access network if a modification of QoS flows happens for the 5G-RG PDU Session. It may remove the QoS flows transferred to the UEs dedicated PDU Session.

In step S16, the SMF acknowledges the establishment of the dedicated PDU session to UE1.

From the above, it is clear that the SMF system is the controlling entity in the network for establishing the dedicated PDU session for UE1 and moving the SDF(s)/QoS flow(s) to the dedicated PDU session of UE1.

The present application also discloses an embodiment for the reverse PDU session mobility procedure of a UE moving from a 5G telecommunications network into a coverage area of a gateway device. In this procedure, the UE requests connectivity with the 5G-RG while having a dedicated PDU session established with the 5G telecommunications network. The UE transfers its PDU Session and QoS flows in an inverse manner to the previous procedure depicted in FIG. 3. The procedure for the 5G-RG and SDF is based on the PDU Session Modification Procedure described in TS 23.502 v16.3.0 clause 4.3.2.2.

FIG. 4 is a schematic illustration of an embodiment showing some aspects of such a PDU session mobility procedure from the perspective of the UE, the 5G-RG and the SMF system in the 5GC.

When, for example, the wireless signal strength of the gateway device 5G-RG, raises above a certain threshold, depending on the access network type, UE1 sends in step S20 a request to access the 5G-RG, including a session management context reference in the dedicated PDU session of the UE1. This reference may include at least one of the UE ID (SUPI, 5G-TMSI, IMSI, etc.) and PDU Session ID and/or possibly other, more specific references.

In step S21, the 5G-RG initiates a PDU Session Modification procedure for modifying QoS flows at the SMF for the 5G-RG as a result of the UE desiring to use the PDU session of the 5G-RG. The PDU Session Modification Request of step S21 includes the session management context reference received from the UE in step S20.

Upon receiving the PDU Session Modification Request from the 5G-RG, the SMF may find information of the PDU Session of UE1 stored in the 5GC based on the received reference to the session management context of the dedicated PDU session of UE1. The SMF may also find the SDFs and QoS flows from that PDU Session information needed for initiating the modification of the PDU session of the 5G-RG in the next step.

As shown in step S22, the SMF may interact with the PCF system using the reference to trace the rules associated with the dedicated PDU session of UE1 and add the rules for UE1 to the PDU session of the 5G-RG.

In step S23, the SMF continues the PDU Session Modification procedure using the PDU Session information about SDFs and QoS flows of the UE found.

After the PDU Session Modification procedure is complete, the SMF may release the PDU Session of the UE as specified in TS 23.502, clause 4.3.4.2 “UE or network requested PDU Session Release for Non-Roaming and Roaming with Local Breakout” starting from step 1e which is SMF initiated PDU Session release. This is shown in steps S24 and S25 of FIG. 4.

In step S26, the SMF acknowledges completion of the PDU Session Modification procedure to the 5G-RG.

In step S27, the UE is informed that it can use the PDU session of the 5G-RG.

The UEs behind a 5G-RG may need a certain QoS for their SDFs. This is managed by the 5G-RG using the PDU Session modification procedure and introducing new QoS flows with packet filters that define the SDFs including the IP address of the UE behind the 5G-RG. These are bound to the PDU Session of the 5G-RG and may need to be rebound to the dedicated PDU Session during UE mobility from a local network to a telecommunications network. The reverse needs to happen during the inclusion of the dedicated PDU session when a UE moves from a telecommunications network to a local network behind a 5G-RG. This is performed by the SMF in case a PCF is not deployed for the particular PDU Sessions.

In one embodiment, if a PCF is deployed during establishment of the dedicated PDU session for the UE moving out of the coverage of the local network, the SMF may choose the same PCF that is handling the 5G-RG PDU Session and initiate the SMF initiated SM Policy Association Modification from the PDU Session Establishment procedure with an indication “Existing PDU Session” and including the session management context reference received from the UE. Based on the reference, the PCF may then find the context from the 5G-RG PDU Session and create a new context for the dedicated PDU Session of the UE. This was shown in step S12 in FIG. 3

Reversely, in one embodiment, if a PCF is deployed during the inclusion of the dedicated PDU session for the UE moving into the coverage of the local network, the SMF may choose the same PCF that is handling the 5G-RG PDU Session and initiate the SMF initiated SM Policy Association Modification from the PDU Session Modification procedure including the reference received from the 5G-RG. The PCF may then find the context from the dedicated PDU Session of the UE based on the reference and add the QoS Flows from that dedicated PDU Session to the PDU Session of the 5G-RG. This was shown in step S22 in FIG. 4.

In one embodiment, the UE may be configured to include a data network name, DNN, in the access request to the gateway device, the DNN referring to a 5G virtual network, wherein the DNN is different from the DNN associated with the established PDU session of the gateway device. When determining this DNN, the gateway device may be triggered to establish a further PDU session with the telecommunications network and include at least one data flow of the UE in the further PDU session. This embodiment may, as an example, be used when the gateway device offers guest access (and has an established PDU session for home users only) and the guest UE desires to connect to a local network associated with the DNN provided in the access request (which may be the home network of the UE).

Home local networks usually have ‘guest’ access which in the WiFi case means a separate SSID and forwarding instance. When UEs that are not considered part of the home local network connect to the guest network, they may be completely isolated from the local network and all traffic is forwarded out of the Residential Gateway. The reason for this type of isolation is preventing access to home devices while allowing the guest UE other Data Network (DNN, usually Internet) access on flat rates usually applicable to fixed network connectivity. This same scenario is possible with a 5G-RG type of RG by either adding multiple subnets or prefixes of which one or more could be used for guests.

It would be desirable for this guest UE to connect to their own home local networks via the ‘guest’ access because of the benefits fixed network connectivity brings. A guest UE can have a PDU Session on a public network that it can move to its own home local network as described with reference to FIG. 4. When the PDU Session of the guest UE is directly via the 5GC, it can then move into the coverage of the ‘guest’ 5G-RG. Since the guest UE may use another DNN for its own home local network, the ‘guest’ 5G-RG needs to establish a new PDU Session to this DNN. In order to do that, the UE has to authorize the 5G-RG to do that because this DNN is not in the allowed DNNs for the guest 5G-RG.

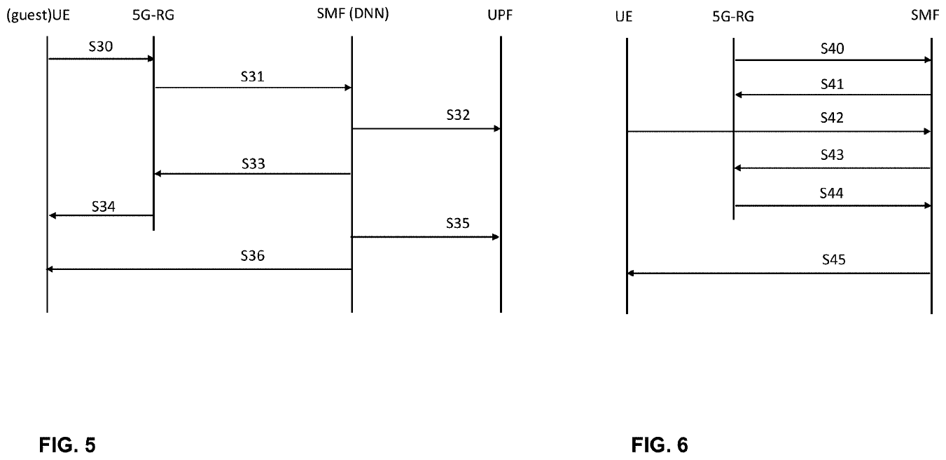

FIG. 5 is a schematic illustration of a PDU session mobility procedure from a 5G telecommunications network to a local guest network.

In step S30, the UE detects availability of a local network provided by a 5G-RG and initiates a connectivity request to the guest 5G-RG. In this request, the UE provides again a reference to a session management context in the telecommunications network of the dedicated PDU session, e.g. UE ID, IP address, PDU Session ID. In addition, the UE may also send a DNN associated with the home local network 5G-RG. As a response to this, the 5G-RG sends the 5G-RG ID to the UE to enable PDU session continuity when the UE moves out of the coverage of the guest 5G-RG.

In step S31, the 5G-RG of the local network sends a PDU Session Establishment request including the reference to the session management context of the dedicated PDU session of the UE and the DNN associated with the home local network 5G-RG, both provided by the UE, to the SMF associated with the DNN. The SMF of the home DNN processes the PDU Session Establishment Request. It may authorize the 5G-RG to create a PDU Session with the requested DNN based on the received reference to the session management context if it contains a UE ID or the UE address. Alternatively, the SMF may request for authorization from the 5G-RG including the address of the UE in a similar way as shown in step S11 (omitted from FIG. 5). This would allow for more dynamic authorization procedure and prevention of unauthorized access. The SMF may also verify if the address given by the UE corresponds to the subnet from the framed route(s) in the 5G-RG's PDU session.

In step S32, the SMF of the home DNN modifies the group forwarding rules for the UE in the UPF to be reachable in this guest PDU Session.

In step S33, the SMF confirms to the 5G-RG that it is authorized to establish a PDU session for the requested DNN and completes the PDU session establishment for the DNN.

In step S34, the 5G-RG grants access to the UE.

In steps S35 and S36, the SMF may release the dedicated PDU Session of the UE as specified in TS 23.502, clause 4.3.4.2 “UE or network requested PDU Session Release for Non-Roaming and Roaming with Local Breakout”.

As already mentioned above, in an embodiment of this disclosure, the gateway devices allocates the address(es) to the UE, e.g. the IP address. Accordingly, it is beneficial for the gateway device and the telecommunications network, to coordinate the address that is assigned to the UE. This is especially helpful, when the UE connects to the telecommunications network prior to having connected to a local network (in which case the gateway device did not have the opportunity to assign the address to the UE).

In one embodiment, this issue is overcome to deploy the gateway device as an external DHCP server for the DNN, enabling the gateway device to allocate IP addresses that it may then also use in the local network.

In another embodiment, a connection exists between a DHCP server in the DNN and the gateway device, so that the gateway device is aware of the IP address assigned to a UE.

In yet another embodiment, the gateway device informs the telecommunications system (e.g. the SMF system) that it is an address assignment server, e.g. a DHCP server, for a DNN during the PDU session establishment procedure of the gateway device. When a UE connects to the telecommunications network for the particular DNN, the telecommunications network may then request and address for the UE from the gateway device. When the UE connects to the local network provided by the gateway device at a later point in time, the gateway device is aware of the assigned address and may allocate the same address.

FIG. 6 is a schematic illustration of the latter embodiment, presenting some steps of a procedure for address assignment to the UE when the UE connects to the telecommunications network.

In step S40, the 5G-RG sends a PDU Session Establishment request to the SMF. The PDU Session Establishment request contains a DNN and an indication that it acts as a DHCP server for that DNN, e.g. a flag that the 5G-RG may assign IP addresses for that DNN.

The SMF that receives the request will store this information and proceed with establishing the PDU session in a regular manner, e.g. as described in more detail in 3GPP TS 23.502, v16.3.0. Step S41 is the completion of the PDU session establishment for the 5G-RG.

If, at a later point in time, the UE sends a PDU Session Establishment request to the same SMF and DNN, step S42, the SMF will find the stored information and send an address assignment request, step S43, to the 5G-RG previously stored in the SMF (for example, because this information was provided in step S40). The address assignment request also contains a reference to the UE, so that the gateway device 5G-RG can administer for which UE the address was provided. The SMF will receive an address from the gateway device in an address response message, shown in step S44 for the UE.

It should be noted that steps S43 and S44 may also be used for authorization and authentication of the UE, as explained above with reference to FIG. 3, step S11.

In step S45, the SMF sends a PDU Session Establishment Accept message with the IP address assigned by the gateway device.

The UE can provide authentication information (e.g. username password) in the PDU establishment request, which will be forwarded to their 5G-RG acting as an external DHCP server. The 5G-RG can authenticate/authorize and provide a 5G-RG token to the UE when connected to the local network for later use during mobility. The 5G-RG token is something arranged between 5G-RG SMF and the 5G-RG, such that when the 5G-RG SMF sees the token, it knows that this has been provided by the 5G-RG to show authorization. The 5G-RG token may be generated specifically for a specific UE and specific 5G-RG (i.e. including UE ID and 5G-RG in the calculation of the token), or may be specific for the 5G-RG only (the 5G-RG has a set of generic tokens to provide). If there is a set of generic tokens, the 5G-RG can obtain these tokens in a configuration procedure with the 5G-RG SMF. If the token is UE specific, the 5G-RG will obtain and exchange the token in a procedure with the 5G-RG SMF. The token procedure may also use a different specific function (e.g. a AUSF, see FIG. 2) in the assignment. This enables both the UE SMF and the 5G-RG SMF to check with this AUSF that an incoming token is correct. Another alternative is that the UE SMF stores the token after 5G-RG token after step S45. That would also allow the UE SMF to check the token when received from the UE. It may also be possible that the UE gets two different tokens (one from the 5G-RG SMF and one from the UE SMF) where the different SMFs can individually show authorization of mobility of SDFs between 5G-RG and UE.

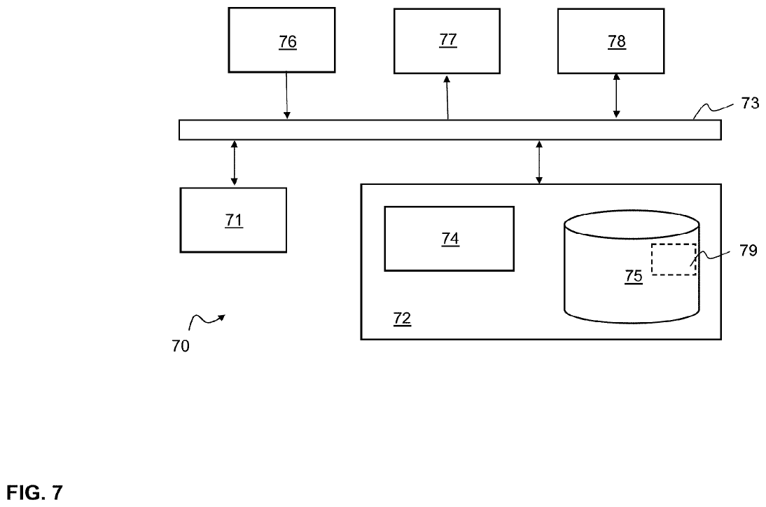

FIG. 7 depicts a block diagram illustrating an exemplary processing system according to a disclosed embodiment, e.g. a UE, a gateway device and/or a server system for performing a network function as disclosed herein. As shown in FIG. 7, the processing system 70 may include at least one processor 71 coupled to memory elements 72 through a system bus 73. As such, the processing system may store program code within memory elements 72. Further, the processor 71 may execute the program code accessed from the memory elements 72 via a system bus 73. In one aspect, the processing system may be implemented as a computer system that is suitable for storing and/or executing program code. It should be appreciated, however, that the processing system 70 may be implemented in the form of any system including a processor and a memory that is capable of performing the functions described within this specification.

The memory elements 72 may include one or more physical memory devices such as, for example, local memory 74 and one or more bulk storage devices 75. The local memory may refer to random access memory or other non-persistent memory device(s) generally used during actual execution of the program code. A bulk storage device may be implemented as a hard drive or other persistent data storage device. The processing system 70 may also include one or more cache memories (not shown) that provide temporary storage of at least some program code in order to reduce the number of times program code must be retrieved from the bulk storage device 75 during execution.

Input/output (1/O) devices depicted as an input device 76 and an output device 77 optionally can be coupled to the processing system. Examples of input devices may include, but are not limited to, a space access keyboard, a pointing device such as a mouse, or the like. Examples of output devices may include, but are not limited to, a monitor or a display, speakers, or the like. Input and/or output devices may be coupled to the processing system either directly or through intervening I/O controllers.

In an embodiment, the input and the output devices may be implemented as a combined input/output device (illustrated in FIG. 7 with a dashed line surrounding the input device 76 and the output device 77). An example of such a combined device is a touch sensitive display, also sometimes referred to as a “touch screen display” or simply “touch screen” that may be provided with the UE. In such an embodiment, input to the device may be provided by a movement of a physical object, such as e.g. a stylus or a finger of a person, on or near the touch screen display.

A network adapter 78 may also be coupled to the processing system to enable it to become coupled to other systems, computer systems, remote network devices, and/or remote storage devices through intervening private or public networks. The network adapter may comprise a data receiver for receiving data that is transmitted by said systems, devices and/or networks to the processing system 70, and a data transmitter for transmitting data from the processing system 70 to said systems, devices and/or networks. Modems, cable modems, and Ethernet cards are examples of different types of network adapter that may be used with the processing system 70.

As pictured in FIG. 7, the memory elements 72 may store an application 79. In various embodiments, the application 79 may be stored in the local memory 74, the one or more bulk storage devices 75, or apart from the local memory and the bulk storage devices. It should be appreciated that the processing system 70 may further execute an operating system (not shown in FIG. 7) that can facilitate execution of the application 79. The application 79, being implemented in the form of executable program code, can be executed by the processing system 70, e.g., by the processor 71. Responsive to executing the application, the processing system 70 may be configured to perform one or more operations or method steps described herein.

In one aspect of the present invention, one or more components of the UE, gateway device and/or system performing an SMF as disclosed herein may represent processing system 70 as described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 71 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope of the claims. The embodiments were chosen and described in order to best explain the principles and some practical applications of the present invention, and to enable others of ordinary skill in the art to understand the present invention for various embodiments with various modifications as are suited to the particular use contemplated.

1. A user equipment, UE, configured for controlling packet data unit, PDU, session continuity in a system comprising a gateway device having an established PDU session with a telecommunications network storing a session management context for the gateway device relating to the established PDU session and providing a local network for a plurality of UEs using the established PDU session of the gateway device for data communication with a data network over the telecommunications network, wherein the UE is configured to control the PDU session continuity by transmitting at least one of:
a PDU session establishment request to the telecommunications network to establish a dedicated PDU session with the telecommunications network, wherein the UE is configured to include in the PDU session establishment request at least one reference to the session management context for the gateway device stored in the telecommunications network;
an access request to the gateway device, wherein the UE is configured to include in the access request at least one reference to a session management context of a dedicated PDU session of the UE in the telecommunications network to nest at least one dataflow into the session management context of the established PDU context of the gateway device.

2. The UE according to claim 1, wherein the UE is configured to include an address, e.g. an IP address, allocated by the gateway device in the PDU session establishment request to the telecommunications network.

3. The UE of claim 1, wherein the UE is configured to determine availability of the local network and to transmit the PDU session establishment request when the local network is unavailable and the access request when the local network is available.

4. The UE of claim 1, wherein the UE is configured to receive the at least one reference to the session management context in a message from the gateway device during connection establishment with the gateway device or during address allocation by the gateway device, wherein the message is, for example, an Association Response message, an ICMPv6 Router Advertisement message, a DCHP Offer message or a DHCP Ack message.

5. The UE according to claim 1, wherein the UE is configured to include a data network name, DNN, in the PDU session establishment request referring to a virtual network associated with the established PDU Session of the gateway device.

6. The UE according to claim 1, wherein the UE is configured to receive an authentication token from the gateway device and to transmit the authentication token with the PDU session establishment request to the telecommunications network.

7. The UE according to one claim 1, wherein the access request by the UE is configured to include the reference in an Association Request, an ICMPv6 Router Solicitation, a DHCP Discover request or a DHCP Request to the gateway device.

8. The UE according to one claim 1, wherein the UE is configured to include a data network name, DNN, in the access request referring to a 5G virtual network, wherein the DNN is different from the DNN associated with the established PDU session of the gateway device.

9. A session management system in a telecommunications network storing a session management context including at least one established PDU session for a gateway device providing a local network for data exchange with a data network over the telecommunications network using the established PDU session, wherein the session management system is configured for at least one of the following:
receiving a PDU session establishment request from a UE, the PDU session establishment request containing at least one reference to the stored session management context of the gateway, wherein the session management system is configured for identifying the stored session management context of the gateway device based on the reference and use at least a part of the identified session management context for establishing a dedicated PDU session for the UE for the dedicated PDU session;
receiving a PDU session modification request from the gateway device containing a reference to a session management context of a dedicated PDU session of the UE and modify the established PDU session of the gateway device by including at least one data flow of the dedicated PDU session in the established PDU session of the gateway device.

10. The session management system according to claim 9, wherein the session management system is configured to receive an address, allocated by the gateway device to the UE, from at least one of the UE and the gateway device upon receiving the PDU session establishment request and assign the received address to the UE for the dedicated PDU session.

11. The session management system according to claim 9, wherein the session management system is configured to execute at least one of:
performing a PDU session modification procedure to modify the established PDU session for the gateway device during or after establishing the dedicated PDU session;
adding at least one dedicated forwarding rule in the telecommunications network to route data for the UE to a dataflow of the dedicated PDU session;
updating the access network of the telecommunications network;
releasing the dedicated PDU session of the UE.

12. The session management system according to claim 9, wherein the session management system is configured to receive an authentication token from the UE in the PDU session establishment request and to transmit the authentication token to the gateway device resp. receive the authentication token from the gateway device to authenticate the PDU session establishment request from the UE.

13. The session management system according to claim 9, wherein the telecommunications network comprises a policy control system configured for storing a policy control context of a gateway device and/or a UE, wherein the session management system is configured for at least one of:
interacting with the policy control system handling the established PDU session of the gateway device using the at least one reference received from the UE to identify the policy control context of the gateway device and to use a part of the policy context of the gateway device associated with the UE for the dedicated PDU session;
interacting with the policy control system handling the dedicated PDU session of the UE using the at least one reference received from the gateway device to identify the policy control context of the UE and to use the policy context of the UE for the established PDU session of the gateway device.

14. The session management system according to claim 9, wherein the session management system is configured for at least one of:
receiving and storing an indication from a gateway device in a PDU session establishment request for the gateway device, the indication indicating that the gateway device is available for assigning addresses to UEs;
requesting an address from the gateway device in response to receiving a PDU session establishment request from a UE and receiving the address from the gateway device;
sending an address assigned by the gateway device to a UE in a PDU session establishment accept message to the UE.

15. A gateway device configured to provide a local network for a plurality of UEs and to provide an established PDU session with a telecommunications network for data communication with a data network over the telecommunications network, wherein the gateway device is configured for at least one of the following:
transmit a reference to a session management context stored in the telecommunications network associated with the established PDU session to at least one of the plurality of UEs over the local network;
receive at least one reference to a session management context stored in the telecommunications network associated with a dedicated PDU session of a UE connecting to the local network of the gateway device and transmit a PDU session modification request including the reference over the telecommunications network to include at least one dataflow of the dedicated PDU session in the established PDU session of the gateway device.

16. The gateway device according to claim 15, wherein the gateway device is configured to receive an address of the UE from the telecommunications network and to compare the received address with the address allocated to the UE over the local network.

17. The gateway device according to claim 15, wherein the gateway device is configured to receive a data network name, DNN, in an access request referring to a 5G virtual network, wherein the DNN is different from the DNN associated with the established PDU session of the gateway device, and wherein the gateway device is further configured to establish a further PDU session, different from the already established PDU session, with the telecommunication network and include at least one data flow of the UE in the further PDU session.

18. The gateway device according to claim 15, wherein the gateway device is configured for at least one of the following:
transmitting an indication to a session management system, the indication indicating that the gateway device is available for assigning addresses to UEs;
receiving a request from a session management system for an address for a UE and providing the address to the session management system for the UE;
allocating an address to a UE in a local network provided by the gateway device, wherein the allocated address corresponds to the address provided to the session management system.
